(19) United States
(12) Patent Application Publication
(10) Pub. No.: US 2001/0015727 A1
(43) Pub. Date: Aug. 23, 2001

(54) Image data display control method and an image display device thereof

(76) Inventors: Hideo Gunji, Tokyo (JP); Keisuke Chiwata, Tokyo (JP); Yasuhide Tanaka, Tokyo (JP)

Correspondence Address: Price and Gess, 2100 S.E. Main Street, Irvine, CA, 92614, US

(21) Appl. No.: 09/829,294

(22) Filed: Apr. 9, 2001

Related U.S. Application Data
(63) Continuation of application No. 08/626,874, filed on Apr. 3, 1996.

(30) Foreign Application Priority Data
Apr. 6, 1995 (JP) 7-80973

(51) Int. Cl. G09G 5/39

(52) U.S. Cl. 345/531

(57) ABSTRACT

In an image data display control device wherein image data that are stored in a video RAM are to be sequentially read and converted into video signals for a display, writing and reading of the image data in the video RAM is so controlled that the capacity of the video RAM can be reduced. The image data display control device that performs such an operation includes a video RAM having an area for storing image data; a converter, which converts image data read from the video RAM into video signals; and a controller, which writes image data to the video RAM and reads the image data from the video RAM. The controller switches between the two areas that are obtained by dividing the area of the video RAM for storing the image data in order to alternately perform data writing and data reading.

### BACKGROUND OF THE INVENTION

1. Field of the Invention

The present invention relates to an image data display controller. In particular, the present invention pertains to an image data display controller, which as one feature has the capability of writing image data into, and of reading out the image data from a video RAM, in storing the image data in the video RAM and sequentially reading out the image data to convert into a video signal for a display.

2. Related Arts

FIGS. 1A and 1B are diagrams for explaining a conventional technique for a device, which stores image data in a video RAM (referred to as VRAM in the diagrams for simplification) and which then sequentially reads out the image data and converts them into video signals for a display.

In FIGS. 1A and 1B, a first video RAM(#1)50 and a second video RAM(#2)51 each have a memory capacity that is large enough to store the image data for one image screen or frame. A monitor 52 converts the image data that are read from the first and second video RAMs 50 and 51 into video signals by using a device (not shown in the drawing) and displays the video signals by scanning them on a display screen.

In FIG. 1A, the image data for one screen or frame are already stored in the first video RAM 50, and are to be sequentially read to display them on the monitor 52. The second video RAM 51 is used for sequentially storing image data for the following screen or frame.

In FIG. 1B, when the image data that were stored in the first video RAM 50 have been displayed, and the image data for one frame have at the same time been stored in the second video RAM 51, the state shown in FIG. 1A is switched to the state wherein the image data are being read from the second video RAM 51 while image data for the next frame are beginning to be stored in the first video RAM 50.

In this manner, in the conventional device shown in FIGS. 1A and 1B, video RAMs are required for two screens or frames, and are alternately employed to perform the writing and the reading of image data.

FIG. 2 is a diagram for explaining the control processing that is performed by another conventional device. This device has a sufficient video RAM for one screen. In FIG. 2A is shown a video signal that is obtained by converting image data that are read from the video RAM. V_{SYNC} is a vertical synchronous signal.

In this conventional device, the writing of image data to the video RAM and the reading of the image data from the video RAM are performed at high speed by DMA (direct memory access) transfer operations. In FIG. 2B are shown the timings for the transfer periods for image data A and image data B, which are transferred by the DMA transfer operation.

Each DMA transfer for the image data A or B is performed during a time period for a vertical synchronous signal V_{SYNC}, as is shown in FIG. 2A. (I) and (II) in FIG. 2A are time periods, of 1/60second each, during which image data A and B are displayed.

Therefore, during a time period for the vertical synchronous signal V_{SYNC} image data are written in the video RAM. During a display period that follows the vertical synchronous signal V_{SYNC} period, i.e., during a time period for horizontal synchronous signal H_{SYNC}, image data is read from the video RAM and is converted into a video signal, and the video signal is displayed. For the conventional device in FIG. 2, only a video RAM for one screen need be prepared.

Lately, images in full colors, such as those for which 16 million colors are used, are being displayed on personal computers and video game machines. If such a device has sufficient video RAM for two screens, as is shown in FIGS. 1A and 1B, a full color display is possible. This is because by employing video RAMs for two screens, data can be read from one of the video RAMs while data are being written to the other video RAM. In this manner, sufficient writing time can be ensured for the transfer of the data for a full color display that has a large capacity.

The possession of sufficient video RAMs for two screens, however, is not an advantage as far as manufacturing costs and device sizes are concerned. For a display that uses a video RAM for one screen or frame, the display control process that has been explained while referring to FIG. 2 is performed.

When an image is displayed for which 16 million colors are used, however, it may be difficult to transfer image data for one frame (320×224 pixels) to the video RAM during the time period for the vertical synchronous signal V_{SYNC}, the period of which is a non-display period. In such a case, image data must be transferred during a display period, which results in the deterioration of the display on the monitor screen.

### SUMMARY OF THE INVENTION

To resolve the above shortcomings in the conventional devices, it is one object of the present invention to provide an image display control method by which the preparation of video RAMs for two screens is avoided.

It is another object of the present invention to provide an image display control method by which a shortcoming of the conventional device is overcome whereby, when a video RAM for one screen is provided, the transfer of image data can not be performed and deterioration of the screen display occurs.

It is an additional object of the present invention to provide an image display device for which the above described image display control method is adapted.

It is a further object of the present invention to provide a video game machine for which the above described image display control method is adapted.

### BRIEF DESCRIPTION OF THE DRAWINGS

FIGS. 1A and 1B are diagrams for explaining a conventional display control method whereby video RAMS for two frames are provided;

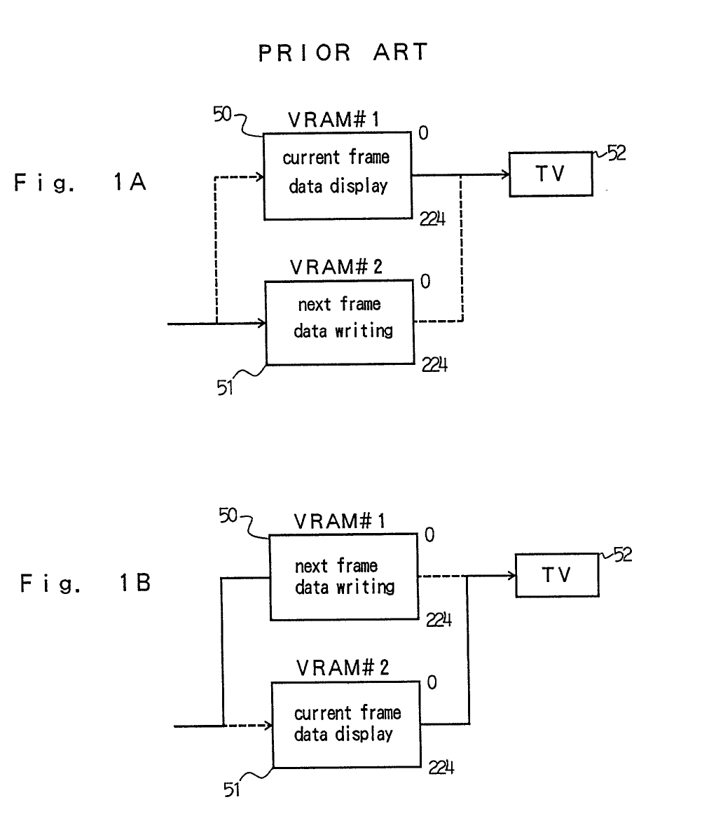

FIGS. 2A and 2B are diagrams for explaining another conventional display control method whereby image data are transferred during the time period for a vertical synchronous signal;

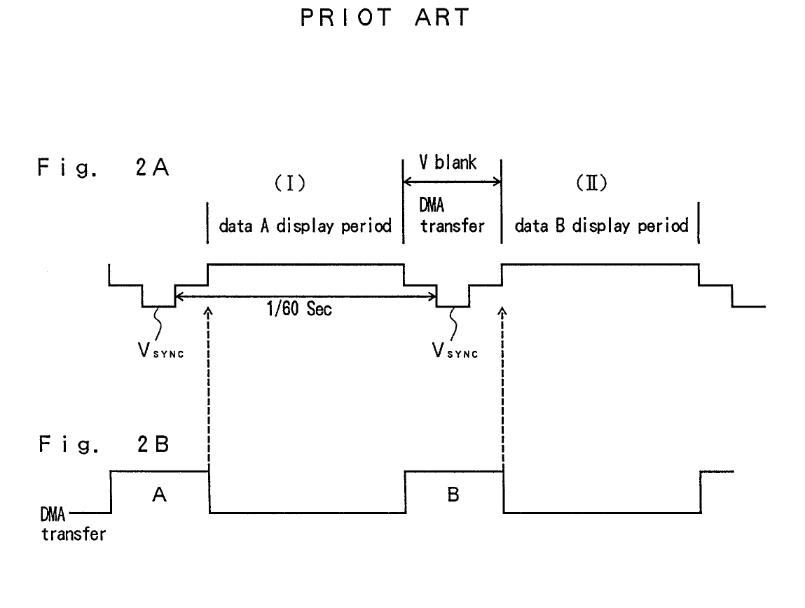

FIG. 3 is a block diagram for explaining the arrangement of a video game machine to which an image data display method according to the present invention is applied;

FIG. 4 is a diagram for explaining an example structure of image data;

FIG. 5 is a block diagram for explaining an example arrangement of a VDP 21 in FIG. 3;

FIG. 6 is a block diagram illustrating the arrangement of a background image generator in FIG. 5;

FIGS. 7A and 7B are diagrams for explaining data transfer to a video RAM according to a first image data display control method of the present invention;

FIGS. 8A and 8B are diagrams for explaining the relationship between video signals and data transfer according to the first image data display control method of the present invention;

FIG. 9 is a flowchart of the processing for one embodiment of the image data display control method of the present invention; and

FIGS. 10A and 10B are diagrams for explaining the relationship of a video signal and image data transfer according to a second image data display control method of the present invention.

### DETAILED DESCRIPTION OF THE PREFERRED EMBODIMENTS

The preferred embodiments of the present invention will now be described while referring to the accompanying drawings. The same reference numbers or symbols are used throughout to denote corresponding or identical components.

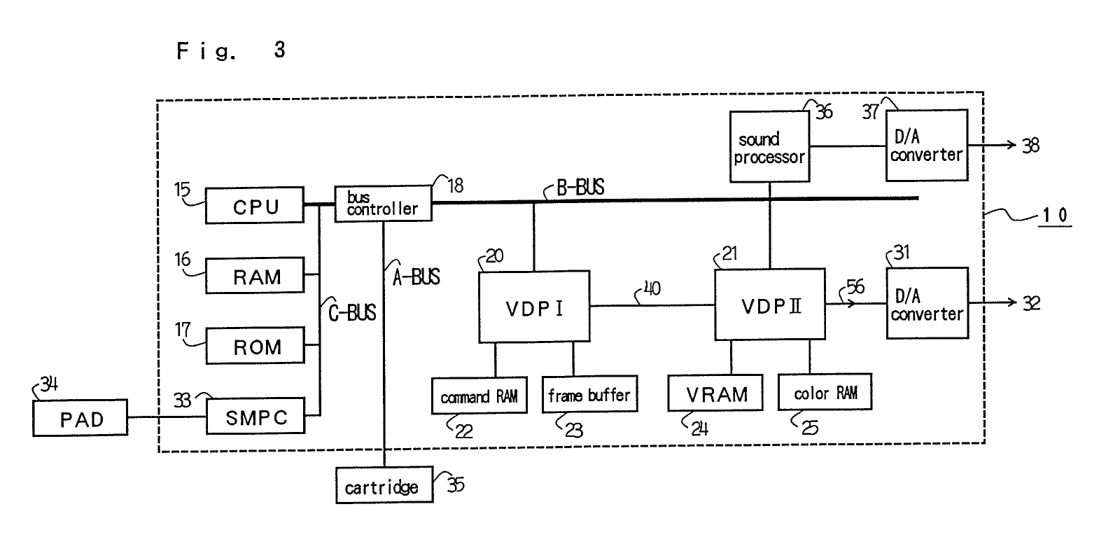

FIG. 3 is a schematic block diagram for explaining the arrangement of a video game machine for which is applied an image data display control method according to the present invention.

In order to more exactly understand the image data display control method of the present invention that in this embodiment is applied for the video game machine shown in FIG. 3, an image processing technique that is employed for a common video game machine will now be described by referring to the specification of the Patent Application that the present assignee filed under the Patent Cooperation Treaty (International Patent Publication No. W095/01630).

For a video game machine, as part of a foreground scene, a character in a game (hereinafter referred to as a sprite) is superimposed on a background scene, such as the ground, the sea, the sky or space. The two scenes are synthesized and the resultant scenic composition is displayed on a monitor.

A game player controls the movements of a sprite, which is the foreground on the screen, by using an input device, such as an input pad to proceed with the game. The movement of the sprite on the display can be accomplished by the shifting of the foreground and the background relative to each other. More specifically, either the background is fixed while the foreground is shifted from side to side and up and down and is rotated, or the foreground is fixed while the background is shifted from side to side and up and down and is rotated. The function that involves the moving of the background from side to side and up and down is called a scroll function.

Conventionally, besides the scroll function, for image display control there are a window function and a priority function. The window function sets a transparent image area called a window and divides a screen by using windows to display different images in separate areas on the screen.

When a window screen overlaps the background or another window screen, the priority function displays one of images in the overlapping portions in consonance with a predetermined priority.

A further explanation of the scroll function will be given. A scroll screen that is displayed by the scroll function is based on a technique whereby the foreground of a screen on which a sprite is displayed is substantially fixed in the center of the screen, while the background is shifted.

As screen types there are a cell type and a bit mapped type. To display a cell type scroll screen, a plurality of pattern data for a cell, each of which consists of the image data for an 8×8 pixel block, are combined (the same pattern data, or different pattern data, as needed, are combined), and the pattern data combination is placed on the screen to provide background image data.

The pattern data for a cell image and the positioning of the cell image where it is laid on the screen are instructed by data that are called pattern name data. The pattern data and pattern name data for a cell image are stored in the video RAM, which is an image memory.

When the background image is to be displayed on the video game machine, either image information from a cassette ROM or a CD-ROM is written, in advance, into the video RAM under the control of a CPU, or image information that have been processed by the CPU are written in the video RAM. The pattern name data are first read from the video RAM, and then are used to access the video RAM. Then, the pattern data for a cell image are read and displayed on the screen of a monitor.

Image data (called pattern data) for a sprite (e.g., an airplane in a flight simulation game), which is displayed in the foreground, are stored in the video RAM by the unit of dots. Thus, a sprite is displayed on the screen by accessing the video RAM for each dot.

Referring back to FIG. 3, an area 10, which is enclosed by broken lines, is the main console of a video game machine to which is connected a control pad 34, an input device that is used by a player to control a game.

The control pad 34 either is a device to which is connected a cord that leads from the main body of the video game machine and that is small enough to hold in the palm, or is an input button that is an integrally formed component of the video game machine.

The control pad 34 is connected to a first bus (C-BUS), which communicates with a CPU 15 of the main console 10 of a video game machine via an SMPC (System Manager and Peripheral Control) 33 that serves as an I/O controller. The SMPC 33 performs the reset management for the entire video game machine, and functions as an interface with an external device, such as the control pad 34.

A cartridge 35 is detachably loaded into the video game machine 10 via a connector. A game program is written and stored in a read-only memory (ROM) in the cartridge 35. The cartridge 35 is accessed by the main console 10 via a second bus (A-BUS), and data are read from the cartridge 35 and input to the main console 10.

The CPU 15, a RAM 16 and a ROM 17, as well as the SMPC 33, are connected to the first bus C-BUS. The CPU 15 reads and executes the game program that is stored in the ROM, and also provides control for the entire video game machine. The CPU 15 is a high speed CPU, a 32 bit RISC, for example.

A bus controller 18 includes a DMA controller (dynamic memory access controller) and an interrupt controller, and serves as a coprocessor for the CPU 15.

A sound processor 36 controls sounds (PCM/FM), and a D/A converter 37 converts a digital signal into an analog signal, which is in turn output from a loud-speaker (not shown).

Besides the bus controller 18 and the sound processor 36, a first video display processor (VDPI) 20, which controls the display of a character, such as a sprite that appears in a game, that is displayed in the foreground on the screen, and a second display processor (VDPII) 21, which scrolls the background, such as by fixing it and turning or shifting it up and down or from side to side, in order to provide the relative movement for a displayed character, are connected to a third bus (B-BUS) in the game machine main console 10.

The first video display processor 20 is connected to a command RAM 22 and a frame buffer memory 23. The first video display processor 20, the command RAM 22 and the frame buffer memory 23 constitute a first image information processing unit that performs image processing for a sprite display, which serves as the foreground on a screen.

The first video display processor 20 may be mounted as an IC chip on a semiconductor chip. In this case, the first video display processor 20 is connected to the command RAM 22, consisting of a DRAM, for example and a frame buffer memory 23 for two screen phases, which has a memory capacity of 2 M bits, for example.

Command data that are transmitted from the CPU 15 and image data that are employed as original images are stored in the command RAM 22. Character image data for a sprite etc., which is shown in the foreground, are developed in the frame buffer 23.

The CPU 15 executes the program stored in the ROM 17 and transmits command data, that are, drawing commands to the first video display processor 20. The first video display processor 20 writes the received command data into the command data RAM 22 as a command table.

The command data are then selected and read out, and sprite modification processing, such as rotation, enlargement, reduction or color calculation, is performed for the data. The resultant data are written at a predetermined address in the frame buffer 23 and image data for one frame of the foreground are developed.

The first video display processor 20 sequentially reads image data for one frame, which were written in the frame buffer 23, and transmits the image data to the second video display processor 21. The information that is used for the control of the drawing is loaded into a system register (not shown) that is internally provided in the first video display processor 20.

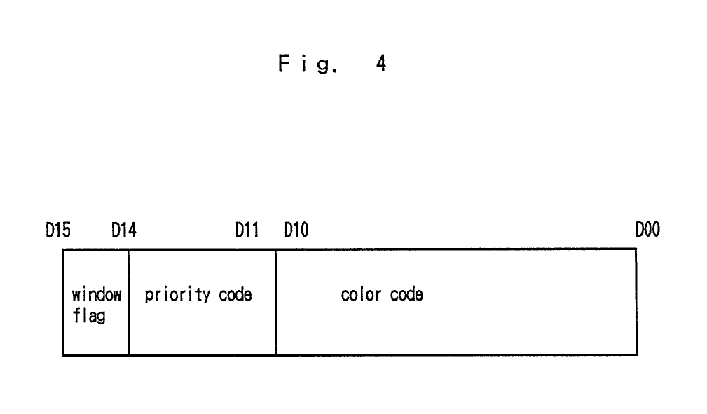

One pixel of the image data that are to be processed by the first video display processor 20 is represented by 16 bits, as is shown in FIG. 4. The less significant 11 bits, which are color code bits that designate colors, are employed as a read address for a color RAM 25.

Bits D11 through D14 serve as priority codes. When a plurality of images are to be overlapped and displayed, a comparison of the priorities of overlapping images is performed for each pixel, and the pixel that has the higher priority is over-displayed on the pixel that has a lower priority.

Such image data for the foreground are input by the first video display processor 20 to a terminal 40, as is shown in FIG. 3. From among the input image data for the foreground, a window flag for the most significant bit D15 is transmitted to a sprite window detector for the second video display processor 21, which will be described later. The color codes and the priority codes for the 15 remaining less significant bits D0 through D14 are transmitted to a display controller for the second video display processor 21.

The second video display processor 21, a video RAM 24 and a color RAM 25 that are the feature of the present invention, serve as a second image information processing unit for performing image processing for a scroll screen. The second video display processor 21, as well as the first video display processor 20, may also be formed on a semiconductor chip.

The second video display processor 21 incorporates a register (not shown in FIG. 3) in which data for the generation of image data are loaded, and is connected to the color RAM 25, which has a predetermined memory capacity and wherein color code is recorded, and the video RAM 24.

The second video display processor 21 reads the data, which are stored in the video RAM 24, in consonance with the data in the incorporated register (not shown) that was previously described, decides the priority in consonance with the data in the image data register for a scroll screen, and generates image display data.

The thus generated image display data are converted into display color data and are then converted into an analog signal by a D/A converter 31. Thereafter, the analog signal is output to a display device (not shown). The image display data are set in the video RAM 24 and the color RAM 25 by the bus controller 18.

According to the feature of the present invention, which will be described later, the video RAM 24 has, as one example, a memory capacity of one screen or frame. One frame memory area is switched for each sub-frame area, which is equivalent to ½of a frame having the same memory capacity, and writing and reading of image data are alternately performed.

In the frame memory areas of the video RAM 24 are stored pattern data, which are data for an 8×8 pixels cell, and pattern name data indicating an address of a storage location for the pattern data that are stored in the color RAM 25. When a background view for one frame is to be formed by setting m×n cells, the pattern name data are employed to instruct which cell that is defined by the color RAM 25 should be used in consonance with the set cell positions.

Therefore, the foreground data from the first video display processor 20 and the background data from the second video display processor 21 are synthesized to provide the previously described image display data.

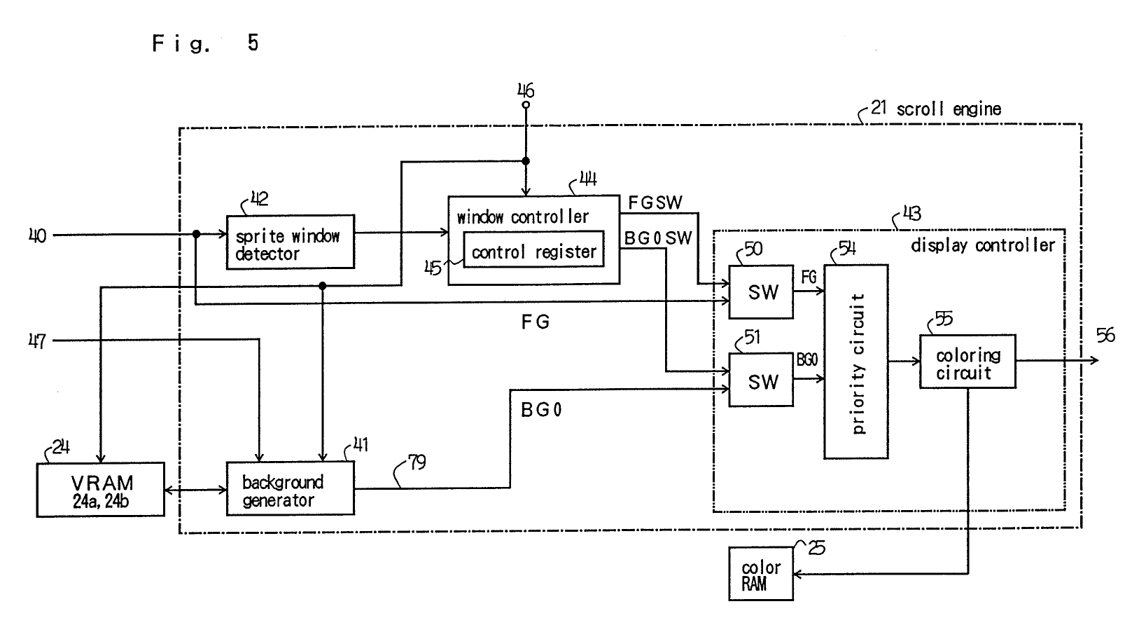

The arrangement of the second video display processor 21 will now be explained while referring to FIG. 5 as an example.

In FIG. 5, a sprite window detector 42 is connected to the first video display processor 20 via the terminal 40. The sprite window detector 42 determines whether or not the most significant bit D15, which is included in the sprite image data (see FIG. 4) that are read from the frame buffer 23 of the first video display processor 20, has been changed. If the detected data value is “1,” it means that the pixel that includes the value is a window pixel. If the data value is “0,” it means that the pixel is not a window pixel. It should be noted that the window pixel is a transparent pixel.

A display controller 43 is connected to a background generator 41 and a window controller 44, and controls image data so as to synthesize sprite image data and background image data.

Switches 50 and 51 are provided for the display controller 43. During a period when a switching signal FGSW is ON, i.e., a period in which the opening of a window is instructed because of the presence of a transparent pixel, the switch 50 changes the color code of image data for the foreground, which is denoted as FG in FIG. 5 to OOH (H represents hex decimal). During a period where the switching signal FGSW is OFF, i.e., a period in which the opening of a window is not instructed, the image data for the foreground FG are output unchanged.

The ON/OFF state of the switching signal FGSW is output by a window controller 44 in consonance with the value “1” or “0” of the most significant bit D15, which is included in the sprite image data (see FIG. 4) that are read from the frame buffer 23.

Similarly, during a period wherein the switching signal BGOSW is ON, the switch 51 changes the color code of image data for a background, which is denoted by BGO in FIG. 5 to OOH. During a period wherein the switching signal BGOSW is OFF, the image data for the background BGO are output unchanged.

The switches 50 and 51 are connected to a priority circuit 54. The priority circuit 54 receives image data for the foreground FG and the background BG0 from the switches 50 and 51.

The priority circuit 54 determines whether or not the color codes of the input image data for the foreground FG and the background BG0 are 00H. When the color codes are 00H, they are assumed to be transparent. As for image data other than 00H, their priorities are compared and the image data that have the maximum priority code is selected and output.

A color circuit 55 is connected to the priority circuit 54. The color circuit 55 accesses the color RAM 25 by using a color code when the image data that are output by the priority circuit 54 are palette type image data.

Then, from the color RAM 25, RGB data, which represent the levels of the three prime colors RGB, are obtained that are stored at an address that corresponds to the color code. The RGB data are output from a terminal 56. When the image data are on an RGB form, the data are regarded as display color data and are output from the terminal 56.

The RGB data that are output from the terminal 56 are converted into an analog signal by the D/A converter 31, as is shown in FIG. 3, and the analog signal is output as an RGB video signal from a terminal 32 and is displayed on a monitor device (not shown).

The window controller 44 employs the most significant bit (D15) of changed image data shown in FIG. 4 to transmit as a window signal, to the display controller 43, the sprite image data that indicates the shape of a sprite image.

A control register 45 is provided for the window controller 44. The contents of the control register 45 can be rewritten by the CPU 15 via a terminal 46. The control register 45 holds the following information items 1 through 5.

The first information item comprises internal and external control bits that indicate on which side a window should be opened, inside or outside of a window that is designated by the window flag for the foreground.

The second information item comprises a sprite window control word of three enable bits for instructing each pixel whether or not a window should be opened for the foreground FG and the background BG0.

The third information item comprises rectangular window position information that represents XY, two-dimensional coordinates describing a start position and an end position for a rectangular window.

The fourth information item comprises a rectangular window control word consisting of internal and external bits and enable bits relative to a rectangular window.

The above described first through fourth information items are designated for a plurality of sprite windows and a rectangular window.

In addition, the fifth information item comprises a product/sum control word for designating an area where a window should be opened; either an area of a logical sum of a plurality of sprite windows and a rectangular window, or an area of a logical product of them.

The window controller 44 is so designed that, in consonance with the contents of the control register 45, it generates the switching signals FGSW and BG0SW for designating positions in the foreground FG and the background BG0 where windows are to be opened, and transmits the signals to the display controller 43.

A background generator 41 for which the method of the present invention is applied will now be described.

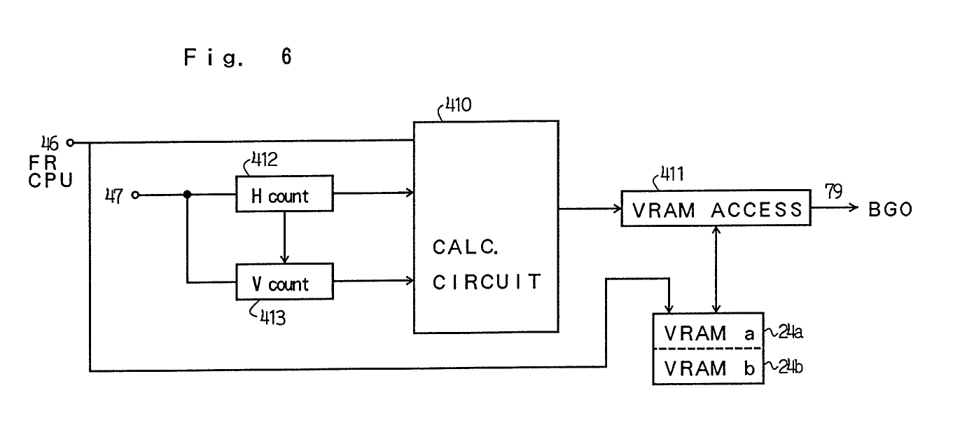

FIG. 6 is a block diagram illustrating an example arrangement of the background generator 41. The background generator 41 generates the background BG0. The pattern name data are read from the video RAM 24, and in consonance with this pattern name data, the pattern data are read from the video RAM 24 and image data for backgrounds BG0 and BG1 are acquired. The image data are 15 bits, excluding window flag D15 shown in FIG. 4.

The background generator 41 includes an image signal converter 410, a video RAM access circuit 411, and horizontal and vertical synchronous counters 412 and 413. In FIG. 6, the image signal converter 410 performs computations for coordinate transformation due to the shifting and the rotation of image data. Such computations are predetermined matrix computations for image data for shifting and rotation, as is described in the previously mentioned PCT application that the present assignee submitted.

Further, the image signal converter 410 acquires coordinates X and Y on a scroll screen, in consonance with the two-dimensional coordinate data of an image signal for which coordinate transformation has been performed, and in synchronism with a horizonal count value from the horizontal synchronous counter 412. The coordinates X and Y are sent to the video RAM access circuit 411.

The horizontal synchronous counter 412 counts clocks that are input from the CPU 15 to the terminal 47 and outputs horizontal synchronous timing signals. The horizontal synchronous timing signals are counted by the vertical synchronous counter 413, which generates vertical synchronous timing signals.

The video RAM access circuit 411 employs the received coordinates X and Y for the scroll screen as a pixel address for the background to access the video RAM 24. The three less significant bits of the coordinates X and Y (when a cell is 8×8 dots) are regarded as pixel position addresses in a cell. The combination of bits, except for the three less significant bits of each X and Y coordinate, which comes to six bits in total, correspond to pattern name addresses where pattern name data are stored.

The video RAM access circuit 411 reads the pattern name data from the video RAM 24 in consonance with the pattern name address. Then, the pattern data for a color code are read from the video RAM 24 in consonance with the pattern data address of the pattern name data and the pixel position address.

Further, the video RAM access circuit 411 adds a priority code from the pattern name data to the pattern data for the color code that are read from the video RAM 24, forms image data according to the format shown in FIG. 4, and outputs the background BG0 at the terminal 79. The background BG0 that is output at the terminal 79 is output as image data through the priority circuit 54, which was previously described while referring to FIG. 5.

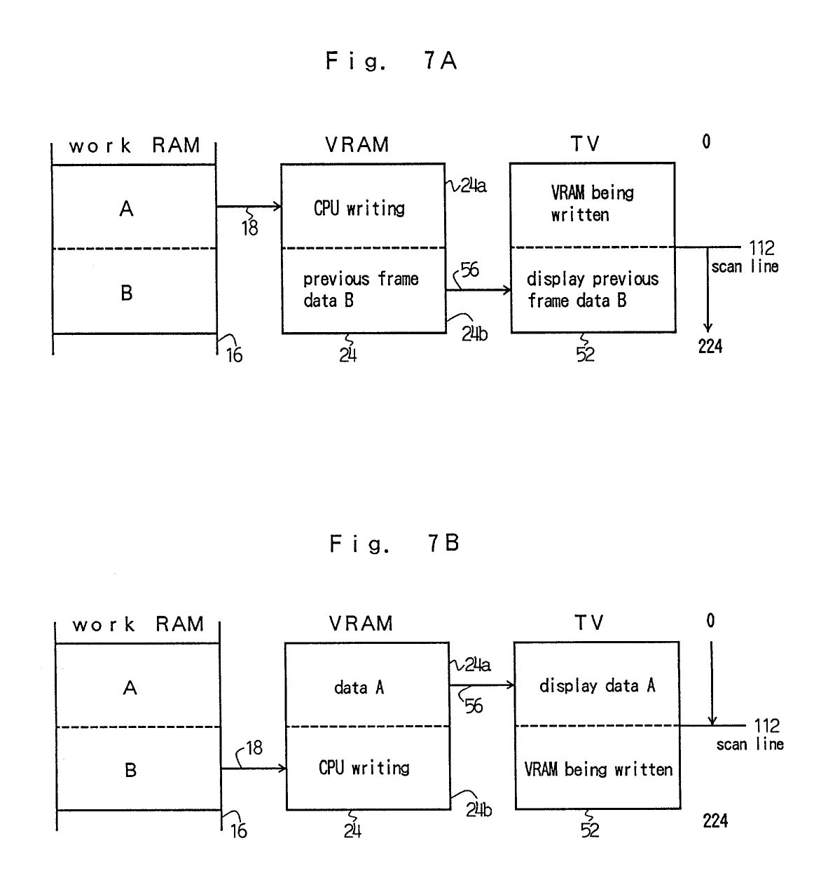

The access processing of the present invention, which is performed by the video RAM access circuit 411 of the video RAM 24, for data writing and reading will now be described while referring to FIGS. 7 through 9.

FIGS. 7A and 7B are used for explaining the transfer of image data to the video RAM 24 and the reading of image data from the video RAM 24. In FIG. 7A, the video RAM in this embodiment has a memory capacity of one frame. The RAM 24 is also divided into at least a first area and a second area, which are obtained by electrical separation, that are, for example, a first half area 24a and a second half area 24b.

In FIG. 7a is shown the contents of a work RAM 16 (see FIG. 3) wherein image data A and B for two fields are stored. Further, the state of the video RAM 24 is that state wherein image data A that is to be displayed next has been transferred from the CPU 15 to the first half area 24a and is being written, i.e., the image data A in the video RAM is being rewritten.

In addition, image data B that has been written is read from the second half area 24b and is displayed on the monitor 7.

That is, the CPU 15 exercises control to enable the accessing of the first area (the first half area 24a in this embodiment) of the video RAM 24, so that image data which follows the image data in the second area can be written while the image data in the second area (the second half area 24b in this embodiment) is scanned and displayed on the display device.

In this embodiment, when one frame of the monitor 7 consists of 224 scan lines, and when a writing position reaches the 112th scan line, which is half of the total, data writing and reading are alternately switched between the two areas of the video RAM 24, i.e., between the first and the second half areas 24a and 24b.

In FIG. 7B is shown the state wherein the writing and reading is switched between the first half area 24a and the second half area 24b shown in FIG. 7A. The image data A is read from the first half area 24a and displayed until scan lines 0 through 112 have been displayed. Thus, at this time, the image data from the work RAM 16 of the CPU 15 is transferred and written in the second half area 24b of the video RAM 24.

It should be noted that in FIG. 7B are shown data that are displayed in an area covering scan lines 112 through 224.

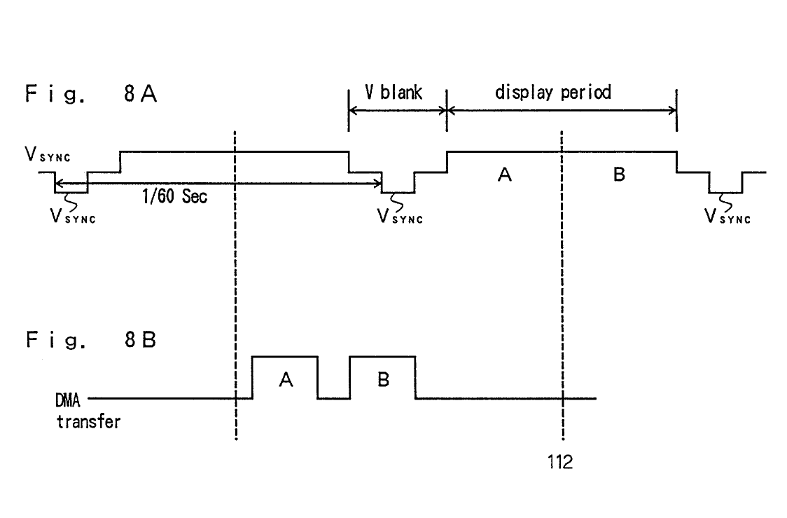

FIGS. 8A and 8B are diagrams for explaining the relationship between a video signal (FIG. 8A) and image data transfer (FIG. 8B) according to the present invention. V_{SYNC} indicates the timing for a vertical synchronous signal from the vertical synchronous counter 413. In this embodiment of the present invention, one frame period is divided into two halves, and image data A and B are to be displayed in the first half and the second half portions of one frame period.

In FIGS. 8A and 8B, the image data A is DMA transferred from the work RAM 16 to the video RAM 24 by the bus controller 18 during the second half period of the frame wherein the image data B is displayed. When a predetermined number is reached, i.e., the 112th horizontal synchronous signal is counted, the image data A is read from the video RAM 24 and is displayed on the display device 52 in the first half portion of the succeeding frame period.

The image data B is data that is to be displayed in the second half portion of the frame. As is shown in FIG. 8a, while the vertical synchronous signal V_{SYNC} is counted, the image data B is transferred from the work RAM 16 under the DMA controlled by the bus controller 18 and is written in the video RAM 24. The writing is completed at least before the second half period begins where the data reading is required for display.

When the 112th scan line is detected (the number of horizontal scan lines from the horizontal synchronous counter 412 is counted by using a counter in the computation circuit 410, and the count value reaches a predetermined number, 112), the writing and reading are switched between the first half area 24a and the second half area 24b of the video RAM 24, and the image data B is read from the video RAM 24 and is displayed during the second half period of the frame.

During the display of the image data B, the image data A is transferred from the work RAM 16 to the video RAM 24, as is described above.

When the 112th horizontal synchronous signal is counted, the operation is switched, with the image data B being read from the video RAM 24 and the image data A being written therein. In this manner, the transfer and display of the image data A and B are alternately repeated. And with a video RAM that has a capacity of only one screen or frame, the image data can be displayed on the monitor without deterioration of the screen image.

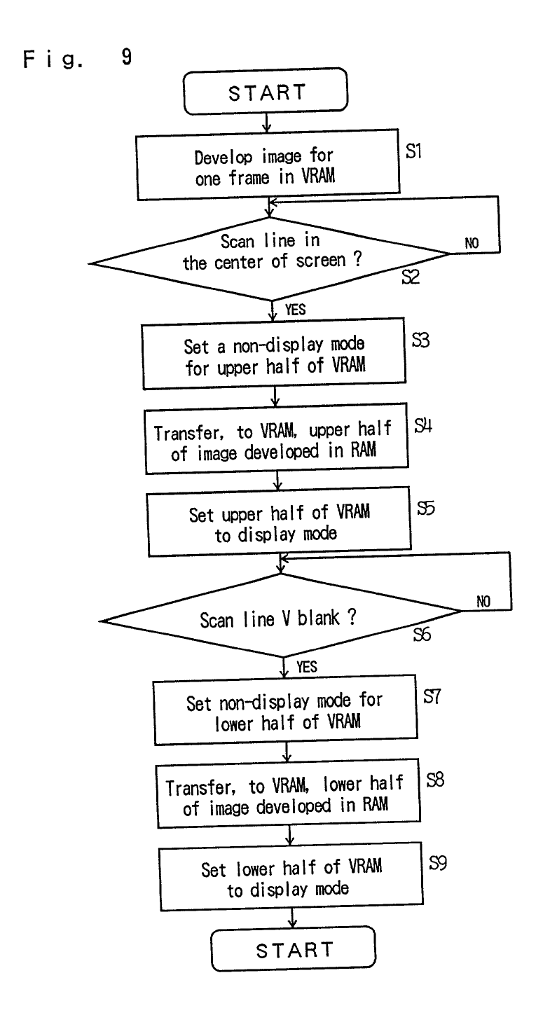

FIG. 9 is a flowchart for the above described processing by the present invention and is used to enable the processing to be more easily understood. When the processing for the device is initiated, image data for one frame are developed in the work RAM 16 by the CPU 15 (step S1).

Then, the second video display processor examines the count value of the horizontal synchronous signals that is held by the counter in the computation circuit 410, and determines whether or not the scan line is located in the center of the screen, i.e., whether or not the scan line is the 112th if one screen consists of 224 scan lines (step S2).

When the scan line 112 is reached, the first half area 24a of the video RAM 24 is set to a non-display mode (step S3). Following this, the first half image data A, of the image data for one screen that is developed in the work RAM 16, is transferred to the video RAM 24 and is written therein (step S4). The first half area 24a of the video RAM 24 is set to a display mode (step S5).

Sequentially, the video display processor 21 determines whether or not the scan line process has reached a period for a vertical synchronous signal (step S6). When the scan line process has reached that period, a non-display mode is set for the second half area 24b of the video RAM 24 (step S7). The lower half image data B, of the image data for a full screen that is developed in the work RAM 16, is transferred to the video RAM 24 (step S8). When the data transfer is completed, the second half area 24b of the video RAM 24 is set to a non-display mode (step S9). The above described process is continuously repeated during the image display period.

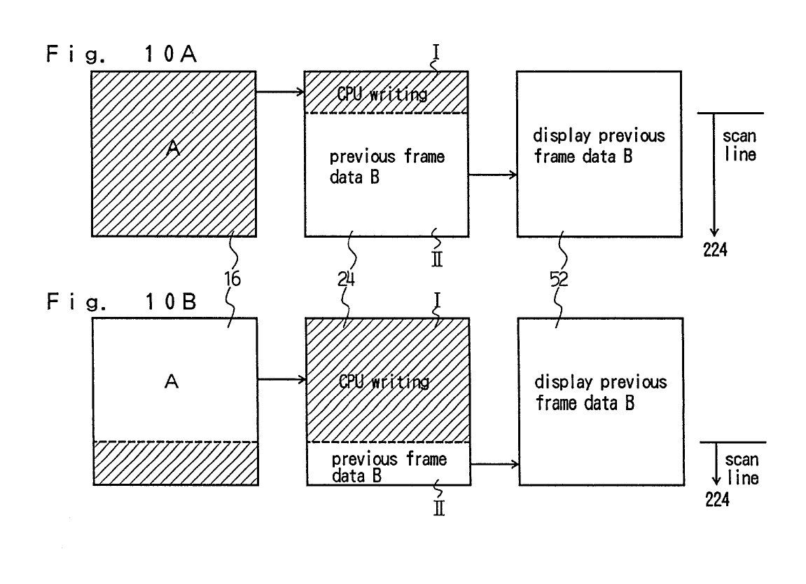

FIGS. 10A and 10B are diagrams for explaining a second embodiment of an image data display control method according to the present invention, for transferring image data to the video RAM 24 and for reading of image data from the video RAM 24.

More specifically, according to the previously mentioned first embodiment of the image data display control method shown in FIGS. 7A and 7B, the writing of image data by the CPU 15 and the reading of image data to the display device are alternately switched relative to the two half areas of one screen.

By the first embodiment of the image data display control method, even when the image data for one frame have been prepared by the CPU 15, the transfer of the image data to the video RAM 24 must wait until data for a half frame of the image data for the previous frame has been read to the display device.

On the other hand, in order to increase the speed for display control, it is necessary for image data to be quickly transferred to the video RAM 24.

The second embodiment of the image data display control method shown in FIGS. 10A and 10B is provided to meet such a requirement. That is, with this method, the time for transferring image data from the CPU 15 to the video RAM 24 can be appropriately controlled by using software.

In FIG. 10A is shown the state where an image that is to be displayed is formed in the work RAM 16. The image data B for the previous frame is being transferred from the video RAM 24 to the display device 52. A first area I is where data have been transferred to the display device, and a second area II is where a part of the image data that is to be transferred to the display device 52 is stored.

In the second embodiment of the present invention, the first area I can be accessed by the CPU 15 for writing, and the second area II can be accessed for data reading.

In FIG. 10B is shown the state where the transfer of the image data to the display device 52 is continued, and in synchronization with the transfer, the first area I, which can be accessed for data writing by the CPU 15, is increased. More specially, by referring to FIG. 10A and FIG. 10B, the writing access of the first area I by the CPU 15 can be sequentially performed in consonance with the transfer of image data from the video RAM 24 to the display device 52.

When the image data B for the previous frame has been transferred to the display device 52 for display on the display device 52, transfer to the display device 52 of the image data that was written by the CPU 15 in the shaded area I is begun, and the writing and transfer of data are repeated in the same manner as is described above.

In the second embodiment, the video RAM 24 has the first area I and the second area II. When the first area I is in a writing enabled state, the second area II is in a transfer enabled state, i.e., ready for reading. And when the first area I is in a reading enabled state, the second area II is in a writing enabled state.

The switching of writing and reading between the first area I and the second area II can be performed as follows.

A read access signal is transmitted from the video RAM access circuit 411 in FIG. 6 to the video RAM 24 to transfer image data to the display device 52. It is therefore easy, by sending the timing for a read access signal to the CPU 15, to use software to notify the CPU 15 that a writing enabled area is available.

If the CPU 15 has generated image data and can transfer them to the video RAM 24, a write access of the writing enabled area is performed that is synchronized with the transmission of a reading access signal to the video RAM 24.

As is described above, according to the embodiments, the present invention has a single video RAM, which is different from the prior art that has two video RAMs. Even with only one video RAM being provided and when there is displayed a great amount of image data that can not be transferred during the vertical synchronous signal period, for example, when a full 16 million colors are displayed in a full 320×224 screen, the image data can be transferred to the video RAM 24 without causing deterioration of the screen display.

The scope of the present invention is not limited to the above embodiments, but is defined by the attached claims. The scope that is the equivalent of the claims is also within the scope of the present invention.

What is claimed is:

1. A display control device comprising:
a video RAM having first and second regions;
a converter operatively connected to said video RAM and constituted so as to read out image data alternately from the first and second regions of the video RAM and convert the read image data into a video signal; and
a controller operatively connected to said video RAM and constituted so as to select alternately one of the first and second regions, and write image data to the selected one of the first and second regions, while the converter is not accessing to the selected one of the first and second regions.

2. A display control device comprising:
a video RAM having memory regions corresponding to at least one frame of image data;
a converter operatively connected to said video RAM for converting the image data to a video signal;
reading means for successively reading out the image data from said video RAM and transferring the read image data to the converter; and
writing means for successively writing the image data to a region of the video RAM, while the reading means is not accessing to the region of the reading means.

3. A display control device comprising:
a video RAM having a memory region corresponding to one frame of image data;
a converter operatively connected to the video RAM for converting the image data read from the video RAM into a video signal; and
a controller operatively connected to the video RAM for controlling to write to and read out the image data from the memory region of the video RAM, so that each half of the frame of the memory region is alternately controlled to write into and read out the image data.

4. A display control device comprising:
a video RAM having memory regions, in which image data are stored;
a converter operatively connected to the video RAM for converting the image data read out from the video RAM into a video signal; and
a controller operatively connected to the video RAM for writing a first portion of the image data into a first region of the video RAM, during a transfer of a second portion of the image data to said converter from a second region of the video RAM.

5. The display control device according to claim 1, 2, 3 or 4 further comprising a CPU for generating the image data, wherein said controller sequentially writes said image data generated by said CPU, into an area in the video RAM from which image data written therein has been transferred to said converter.

6. An display control device comprising:
a CPU for generating image data;
a video RAM having an storing area for storing the image data generated by the CPU;
a converter operatively connected to the video RAM for converting the image data read out from said video RAM into a video signal; and
a controller for alternately switching between first and second areas, which are obtained by dividing the storing area of said video RAM to store said image data sent from the CPU and to read out from the video RAM and transfer the image data to said converter.

7. The data display control device according to claim 6, further comprising counting means for obtaining a count value of scan lines for displaying said video signal, wherein said controller detects a timing when said count value of said scan lines for said video signal, which is obtained by said counting means, reaches a predetermined value, and controls said writing and said reading in consonance with said timing that is detected.

8. The image data display device according to claim 7, wherein said timing that is set when said count of said scan lines reaches said predetermined value is that time when said count of said scan lines is one half of those scan lines required to display one screen.

9. A display control device comprising:
a CPU;
a video RAM having an area for storing image data; and
a video processor, including a background generator and a display controller connected to said background generator, for accessing said video RAM to sequentially read image data for an image to be displayed and for generating background image data under the control of said CPU, said video processor alternately switching data writing and reading between areas that are obtained by dividing said area of said video RAM for storing said image data.

10. The display control device according to claim 9, wherein said video processor has count means for obtaining a count of scan lines for displaying said video signal, and wherein said video processor detects a timing when said count of said scan lines for said video signal, which is obtained by said counting means, reaches a predetermined value, and controls said writing and said reading in consonance with said time that is detected.

11. The display device according to claim 10,
wherein said timing that is set when said count of said scan lines reaches said predetermined value is a time when said count of said scan lines is one half of those scan lines required to display one screen.

12. An image data display control method for storing to and reading out image data from a video RAM, the method comprising the steps of:
reading out the image data from a first region of the video RAM;
transferring the read out image data to a converter;
converting the transferred image data into a video signal in the converter; and
writing the image data into a second region of the video RAM, during transferring the read out image data to the converter from a first region of the video RAM.

13. The display control method according to claim 12, further comprising the steps of generating the image data, sequentially writing said image data generated into an area in the video RAM from which image data written therein has been transferred to the converter.
